(19) United States
(12) Patent Application Publication
(10) Pub. No.: US 2019/0141561 A1
(43) Pub. Date: May 9, 2019

(54) DYNAMIC TOPOLOGY MANAGEMENT IN SELF-BACKHAULING WIRELESS MESH NETWORKS

(71) Applicant: ARGELA YAZILIM VE BILISIM TEKNOLOJILERI SAN. VE TIC. A.S., ISTANBUL (TR)

(72) Inventors: CAN ALTAY, ISTANBUL (TR); BENGI MIZRAHI, ISTANBUL (TR); ARDA AKMAN, ISTANBUL (TR); SEYHAN CIVANLAR, ISTANBUL (TR)

(21) Appl. No.: 15/806,558

(22) Filed: Nov. 8, 2017

(51) Int. Cl. H04W 28/02; H04L 12/24; H04L 12/18; H04W 76/02; H04W 24/02; H04W 36/22; H04W 40/24

(52) U.S. Cl. CPC H04W 28/0205; H04L 41/12; H04L 12/1886; H04W 84/18; H04W 24/02; H04W 36/22; H04W 40/246; H04W 76/025

(57) ABSTRACT

An implementation is developed to dynamically change the topology of a mesh network connectivity comprised of many mesh nodes and route IP packets across the network in a wireless network, wherein an IP tunnel and a control connection are established between a pair of mesh nodes using a mesh application (called, Mesh App). The Mesh App has several key functions such as collecting local wireless user equipment IP addresses from the local Core Network, and remote IP addresses and routing information from its neighbor Mesh Apps, enabling routing of data traffic hop by hop across the network. Furthermore, it changes the UEs in the ‘reject list’ forcing the disconnection of certain UEs and backhaul modems so as to alter the topology or the network, and distributing the topology change information to its neighbors.

### BACKGROUND OF THE INVENTION

### Field of Invention

The present invention relates generally to the field of wireless mesh networks. More specifically, the present invention is related to a self-backhauling mesh/relay system and a method that is specifically designed for 5G, 4G and 3G technologies to perform an instantly reconfigurable network topology, load balancing and resource partitioning across a mesh network.

### Discussion of Related Art

Any discussion of the prior art throughout the specification should in no way be considered as an admission that such prior art is widely known or forms part of common knowledge in the field.

In remote locations, where well-planned wireless infrastructure is not yet deployed, or when the base stations are moving as in military or public safety applications, bringing the cellular data communications service for everyday use or under emergency conditions using a fixed wire-line core network infrastructure is impossible. In such areas where a facilities infrastructure is not available, it is much easier to use wireless mesh networks wherein base stations are directly interconnected with wireless/air interfaces to relay data traffic in a hop-by-hop fashion. There are many alternative air interface technologies to use in wireless mesh networks. Orthogonal Frequency-Division Multiple Access (OFDMA) is one of the most popular air interface technology for Wireless Mesh Networks because of its advantages in high data transmission rate, mitigation in frequency selectivity in multi-path environments, robustness against frequency selective fading, and ability to provide frequency diversity in multi-user environments.

In order to meet the public safety, military and rural community communications requirements, mesh networks must satisfy the following requirements: (1) establishing uninterrupted and reliable device-to-device and device-to-infrastructure communications aligned with 3G/4G/LTE standards; and (2) developing prioritization mechanisms in data delivery.

The key invention of this patent application is to create a new control messaging sequence between adjacent mesh nodes to instantly change the network connectivity/topology and doing so, to redistribute the traffic load among mesh nodes to meet the aforementioned requirements. Broadcasting the topology and routing information amongst mesh nodes, as opposed to relaying them to a centralized system for routing and topology determination achieves this.

Embodiments of the present invention are an improvement over prior art systems and methods.

### SUMMARY OF THE INVENTION

The present invention provides a method and a special mesh node design for wireless communications that combine on a single air interface across a pair of mesh nodes both data transmission and the control messaging exchange to make packet data routing in a wireless mesh network with many such pairwise interconnected mesh nodes more dynamic and efficient. Using (1) a simple over the air connection (called backhaul) created via a regular user equipment (called backhaul UE) in a mesh node that attaches to the base station component of an adjacent mesh node, (2) a mesh application, according to an aspect of this invention, implemented in each mesh node as an additional software component (1) for storing (a) the list of UEs (including backhaul UEs) to reject or accept, said list being reconfigurable, and (b) the adjacency information of all mesh nodes, and (3) a sharing mechanism of the aforementioned information with the adjacent mesh nodes on a control channel on the backhaul connection, attaining a periodic or event driven information broadcast across all the network, and (4) a method for determining overall routing of data packets across the mesh network, and dynamically altering and optimizing radio resource utilization by handing over UEs between mesh nodes. Exchange of control messages according to an aspect of this invention between mesh nodes and the mesh application provides the advantage to coordinate topology modification and routing between neighboring mesh nodes.

In one embodiment, the present invention provides a method as implemented in a mesh network, the mesh network comprising at least a first mesh node and a remote second mesh node, the first mesh node comprising a first base station, a first backhaul user equipment (UE), and a first integrated computer implementing a first core network and running a first mesh application, the first mesh node directly attached to at least a first radio access user terminal, the second mesh node comprising a second base station, a second backhaul user equipment (UE), and a second integrated computer implementing a second core network and running a second mesh application, the second mesh node directly attached to at least a second radio access user terminal, the first mesh node interconnected with the second mesh node via the first backhaul UE communicating with the second base station over an air interface to provide the backhauling or hopping of data traffic, the method as implemented in the first mesh node comprising: establishing a control connection towards the second mesh application of the second mesh node via the first backhaul UE's communicating with the second base station of the second mesh node, the control connection exchanging control messages; and establishing a data connection towards the second mesh application of the second mesh node to exchange data packets between the first radio access user terminal attached to the first mesh node and the second radio access user terminal attached to the second mesh node.

In another embodiment, the present invention provides a topology alteration method as implemented in a mesh network, the mesh network comprising at least a first mesh node, a remote second mesh node, and a remote third mesh node, the first mesh node comprising a first base station, a first backhaul user equipment (UE), and a first integrated computer implementing a first core network and running a first mesh application, the first mesh node directly attached to at least a first radio access user terminal, the second mesh node comprising a second base station, a second backhaul user equipment (UE), and a second integrated computer implementing a second core network and running a second mesh application, the second mesh node directly attached to at least a second radio access user terminal, the third mesh node comprising a third base station, a third backhaul user equipment (UE), and a third integrated computer implementing a third core network and running a third mesh application, the third mesh node directly attached to at least a third radio access user terminal, the first mesh node interconnected with the second mesh node via the first backhaul UE communicating with the second base station over a first air interface to provide the backhauling or hopping of data traffic, and the second mesh node interconnected with the third mesh node via the second backhaul UE communicating with the third base station over a second air interface to provide the backhauling or hopping of data traffic, the method comprising: each mesh application at a corresponding mesh node storing a User Equipment (UE) reject list containing a listing of those UE whose connection attempt to that corresponding mesh node will be rejected with an associated reject reason, the UE reject list containing at least the identifier of the corresponding mesh node's backhaul UE, so that when the corresponding mesh node's backhaul terminal tries to attach to its local base station, the connection is rejected by the local base station to force corresponding mesh node's backhaul user terminal to attach to a remote mesh node's base station; the first mesh application sending a topology directive message to the second mesh application to request the rejection of a connection request of the first backhaul UE to the second mesh application, the second mesh application adding the first backhaul UE's identifier to its UE reject list and rejecting the first backhaul UE's attachment to the second base station; and the first backhaul UE being disconnected from both the first and second base stations attempting to attach the third base station, connecting and therefore altering the topology of connectivity between the three mesh nodes.

In yet another embodiment, the present invention provides a mesh network comprising: a first mesh node comprising a first base station, a first backhaul user equipment UE), and a first integrated computer implementing a first core network and running a first mesh application, the first mesh node directly attached to at least a first radio access user terminal, a second mesh node comprising a second base station, a second backhaul user equipment (UE), and a second integrated computer implementing a second core network and running a second mesh application, the second mesh node directly attached to at least a second radio access user terminal, the first mesh node interconnected with the second mesh node via the first backhaul UE communicating with the second base station over an air interface to provide the backhauling or hopping of data traffic, the first mesh node establishes a control connection towards the second mesh application of the second mesh node via the first backhaul UE's communicating with the second base station of the second mesh node, the control connection exchanging control messages; and establishes a data connection towards the second mesh application of the second mesh node to exchange data packets between the first radio access user terminal attached to the first mesh node and the second radio access user terminal attached to the second mesh node.

In another embodiment, the present invention provides a mesh network allowing topology alteration comprising: a first mesh node comprising a first base station, a first backhaul user equipment (UE), and a first integrated computer implementing a first core network and running a first mesh application, the first mesh node directly attached to at least a first radio access user terminal, a second mesh node comprising a second base station, a second backhaul user equipment (UE), and a second integrated computer implementing a second core network and running a second mesh application, the second mesh node directly attached to at least a second radio access user terminal, a third mesh node comprising a third base station, a third backhaul user equipment (UE), and a third integrated computer implementing a third core network and running a third mesh application, the third mesh node directly attached to at least a third radio access user terminal, the first mesh node interconnected with the second mesh node via the first backhaul UE communicating with the second base station over a first air interface to provide the backhauling or hopping of data traffic, and the second mesh node interconnected with the third mesh node via the second backhaul UE communicating with the third base station over a second air interface to provide the backhauling or hopping of data traffic, wherein: each mesh application at a corresponding mesh node storing a User Equipment (UE) reject list containing a listing of those UE whose connection attempt to that corresponding mesh node will be rejected with an associated reject reason, the UE reject list containing at least the identifier of the corresponding mesh node's backhaul so that when the corresponding mesh node's backhaul terminal tries to attach to its local base station, the connection is rejected by the local base station to force corresponding mesh node's backhaul user terminal to attach to a remote mesh node's base station; the first mesh application sending a topology directive message to the second mesh application to request the rejection of a connection request of the first backhaul UE to the second mesh application, the second mesh application adding the first backhaul UE's identifier to its UE reject list and rejecting the first backhaul UE's attachment to the second base station; and the first backhaul UE being disconnected from the second base stations attempting to attach the third base station, connecting to the third base station and therefore altering the topology of connectivity between the three mesh nodes.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 depicts the entities included for data communication between two UEs in a prior art cellular network.

FIG. 2 depicts the contents of a mesh node, comprising of the prior art entities and the mesh application that is responsible for mesh operations according to the aspect of this invention.

FIG. 3 shows the connectivity between two mesh nodes according to an aspect of this invention.

FIGS. 4A and 4B show two different topologies of the same mesh network attained using the mesh application according to an aspect of the invention.

FIG. 5 shows a block diagram of the mesh application, which is the system of the invention.

FIG. 6 shows the establishment of control communications across two mesh noes.

FIG. 7 illustrates the INFO message sequence.

FIG. 8 illustrates a simple topology management scenario.

FIG. 9 illustrates a simple load-balancing scenario.

FIGS. 10A and 10B show the attachment and handover procedures of a UE.

FIG. 11 depicts a messaging flow according to the method of invention.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

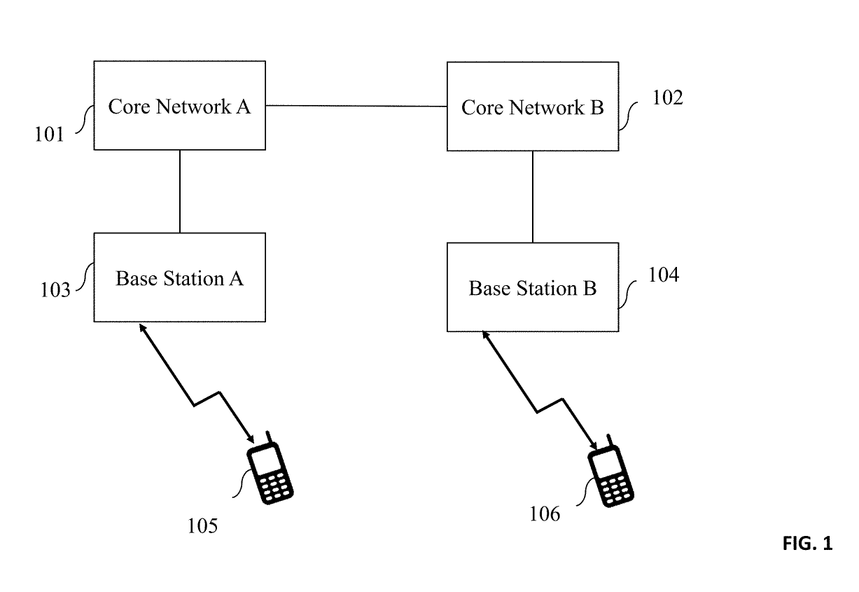

Cellular communication technologies usually require a high amount of infrastructure behind the base stations for routing and forwarding of data packets to their destinations. In a traditional cellular deployment, as illustrated in FIG. 1, the User Equipment (UE) A, 105, wherein a UE is always a mobile equipment such as a cell phone, connects through the air interface to Base Station A, 103, and registers to Core Network A, 101. The Core Network is also known in prior art as Packet Core Network (PCN). The Core Network is necessary for routing of data packets within and outside its coverage area. Although not shown in the diagram, Base Stations may interconnect to neighboring Base Stations with a cellular interface for mainly signaling and packet forwarding during handover. The Base Station and Core Network, together, are responsible for interference mitigation and coordination in case same frequency bands are used between neighboring base stations. When the UE A, 105, wants to send a data packet to UE B, 106, it sends a request to Core Network A, 101. The Core Networks are responsible for session establishment and routing of packets. Once the session is established, the UE A, 105, can send packets traversing the path through Base Station A, 103, Core Network A, 101, Core Network B, 102, Base Station B, 104, to UE B, 106. Note that other than the air interface between the UEs and the Base Station, all other interfaces connecting entities in the network are all wire-line. Furthermore, the locations of base stations and core network components are pre-planned and fixed in contrast to mesh networks. Just a single node with a core network and base station can serve a large number of UEs, providing connectivity between any pair of attached UEs for data and voice transmission.

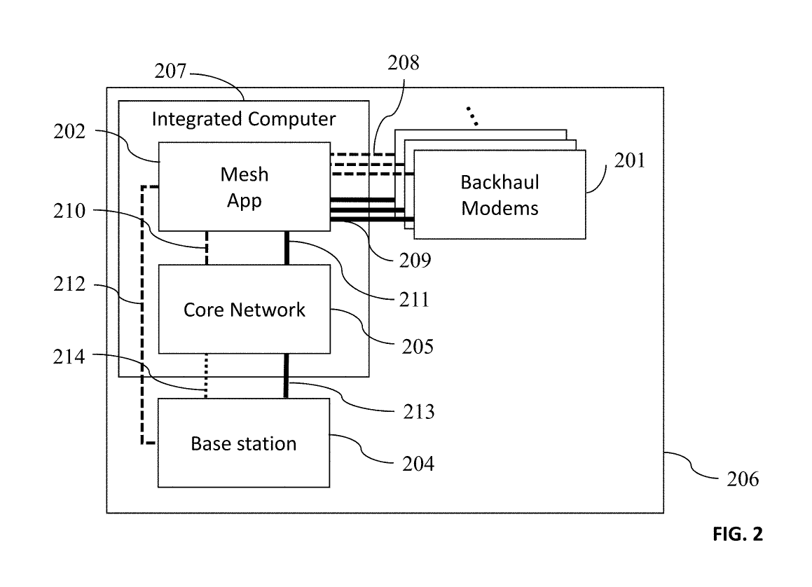

According to one embodiment of the invention, an apparatus for wireless communication is provided which should allow hopping of packets from one mesh node to another without using any wire-line backhaul infrastructure. An exemplary arrangement of the building blocks of an embodiment of the invention is shown in FIG. 2. Box 206 shows the enclosure of a so-called mesh node. Each mesh node comprises three hardware entities, a base station 204, an integrated computer 207, and one or more backhaul UEs/modems 201. Integrated computer 207 includes Core Network 205, and a topology and routing management application, Mesh App 202, which handles the functionalities of this invention. While the Backhaul UE (or simply called the ‘modem’), 201, and the Core Network, 205, and Base Station 204 are entities that could be used directly from third parties, the Mesh Application (also referred here as the Mesh App), 202, is a new system specific to this invention. Note that according to prior art, a mesh node comprises of a Mesh Base Station, and a Core Network only. Mesh Base Station, 204, of one mesh node connects to a Backhaul UE (or modem), 201 of another mesh node over the air interface to provide the backhauling (or hopping) of data traffic. However, a Backhaul UE, 201, is never allowed to connect to the Mesh Base Station, 204, of its own Mesh Node, 206, enforced by Mesh App, 202, even though a Backhaul UE, 201, can normally connect to any base station.

Between the base station, 204, and core network, 205, the S1-AP interface, 213, includes the control channel, and the S1-U interface, 214, includes the IP tunneled data communication. Both of these interfaces are well defined in LTE standards documents, and may be replaced with other standard interfaces defined for UMTS or 5G.

According to one embodiment of this invention, Mesh App, 202, has three different control interfaces for: (1) management of the core network, 210, (2) management of the base station, 212, and (3) management of the backhaul modems, 208. Mesh App, 202, also has two types of data forwarding interfaces; (1) towards the backhaul modems, 209, to forward data packets to other mesh nodes by tunneling, and (2) towards the core network, 211, to forward data packets to other mesh nodes by tunneling or to UEs directly attached to that mesh node without tunneling.

Backhaul UE/modem 201 is a general purpose UMTS (3G), LTE (4G), or 5G modem which is connected with a physical USB connection to the mesh node. There may be several backhaul modems per mesh node. However, each backhaul modem 201 can only be connected to one remote mesh node's base station at a time. The functionality of the control interface, 208, of a backhaul modem is fairly limited using off the shelf modems. Two commonly available examples of the control interface are AT and QMI, neither of which provide the needed functionality for cell id or TAC/LAC specific cell selection, the importance of which will be described later. These control interfaces provide received signal power and signal to noise ratio (SINR) of the connected base station and an attribute to reset the backhaul modem.

Core Network 205 has a user interface for instantaneous notifications of UE attach, detach, handover, or cell reselection occurrences. It also provides an interface for configurable ‘UE reject list’ where each entry contains the International Mobile Subscriber Identity (IMSI) of a UE and reject cause for ‘attach reject’ and ‘tracking area update (TAU) reject’ messages. When a UE in that reject list of Core Network 205, and it tries to attach Base Station 204, the connection gets rejected. Core network 205 also provides a Command Line Interface (CLI) for manual network initiated detach operations for a specific IMSI.

Base Station 204 can be a gNode-B for a 5G, an eNode-B for an LTE (4G), or a Node-B for a UMTS (3G) based network. Base station 204 provides a management interface, 212, to trigger handover for any technology. For UMTS (3G), the base station may also provide a configurable Access Point Name Control List (ACL), where each entry contains IMSI of the UE that can connect to the base station. ACL support provides access and topology control option with the base station control interface, 212, in UMTS (3G).

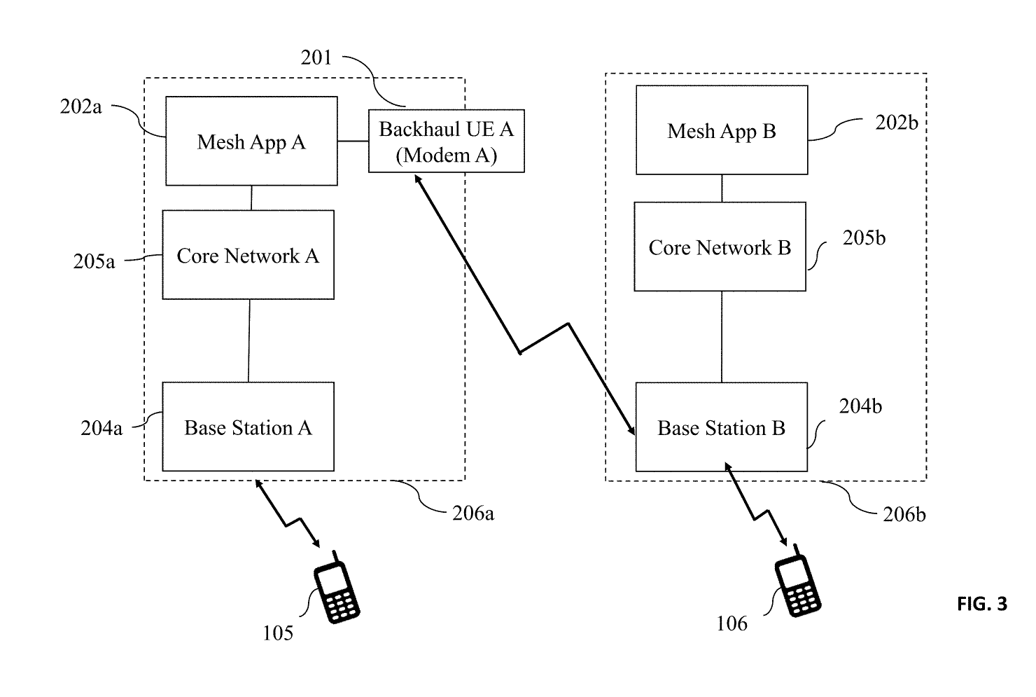

FIG. 3 illustrates an example mesh network with two Mesh Nodes, 206a and 206b, connected via a backhaul radio connection for routing per this invention. Radio Access (user) UE 105 is attached to one mesh node, 206a, in the network while Radio Access UE 106 is attached to another mesh node, 206b. UE 105 and 106 communicate with one another using the backhaul radio connection. Because they are attached to different mesh nodes, the data traffic from UE 106 is first sent to Mesh Base Station 204b via the radio access link. In turn, the traffic is routed from the Base Station 204b towards Backhaul UE 201 via the backhaul radio link, and then to Core Network 205a via Mesh App 202a towards Mesh Base Station 204a and to the UE 105 therefrom.

When a radio access the UE is connected to a base station of a Mesh Node, it is registered in its Core Network. Namely, the UE acquires its IP address from that Core Network. Note that a backhaul UE A 201 registers with the Core Network 205b, the Core Network of the adjacent Mesh Node, 206b, whereas radio access UE 105 registers with Core Network 205a, the Core Network of the Mesh Node it directly attaches to. UE 105 obtains its IP address from Core Network 205a, while UE 106 and backhaul UE 201 obtain their IP addresses from Core Network 205b.

A Core Network obtains information about all UEs (both radio access of backhaul) from a Home Location Registrar (HLR) database within itself. This database in each Core Network contains the IMSI of each UE along with the corresponding static and uniquely assigned IP address, which has to be preconfigured by the operator at the beginning of operation. Therefore, a Core Network knows all IP addresses used by radio access UEs attached to it. Note that for the packets of UEs to remain as unique within the Mesh Node, the Core Network has to disable Network Address Translation (NAT), so that the source and destination IP addresses remain as the original addresses and could be routable using the IP header of those data packets.

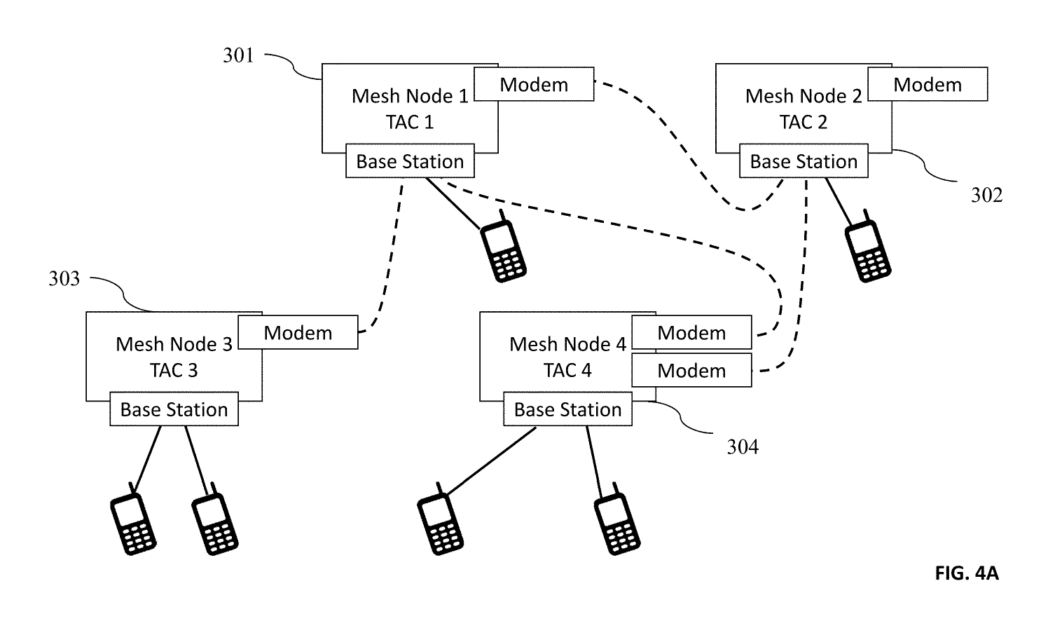

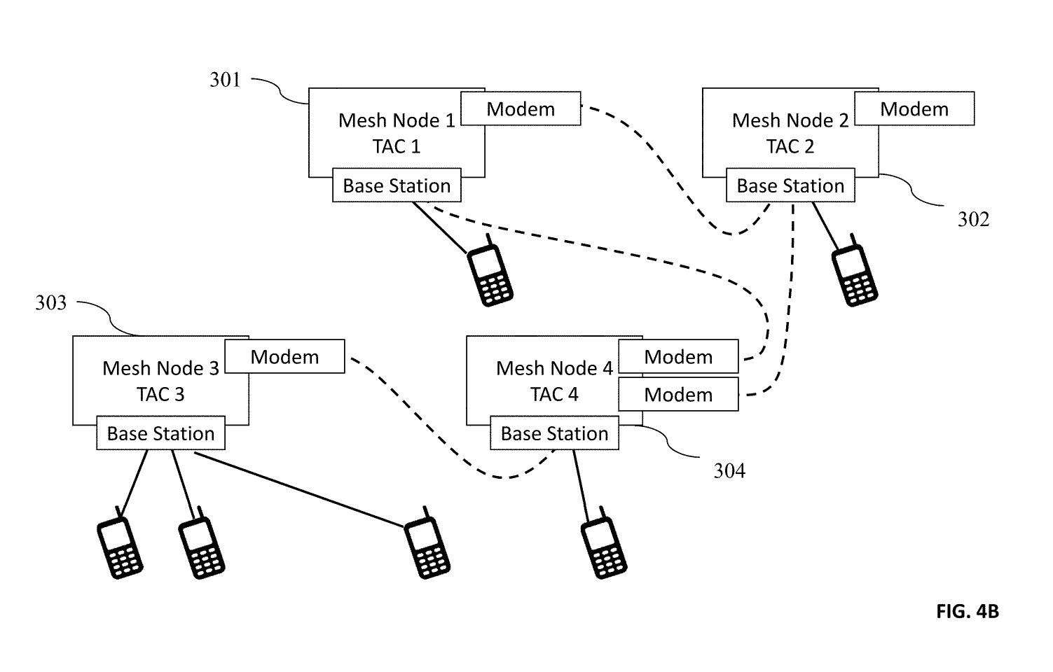

Two simple topologies of the same mesh network with four mesh nodes are illustrated in FIG. 4A and 4B. In the network of FIG. 4A, mesh node 303 connects to mesh node 301 via a radio interface using the backhaul modem of node 303. Similarly, mesh node 301 connects to mesh node 302, and mesh node 304 connects to both mesh nodes 301 and 302. Also, radio access UEs are illustrated that directly connect to the mesh nodes. In the network of FIG. 4B, the topology of the network is altered such that mesh node 303 now connects to mesh node 304 via modem (or backhaul UE) to adapt backhaul topology to changing channel conditions and distances between mesh nodes. Note that the radio access UE under mesh node 4 is moved to mesh node 3 in FIG. 4B for load balancing. Identical mesh nodes are used in both FIG. 4A and 4B, but completely different network topologies are obtained by forcing to reconnect backhaul UEs to different base stations, according to an aspect of this invention.

Base station in each mesh node must be configured with a different cell id and Tracking Area Code (TAC) in LTE [or a different Location Area Code (LAC) in GSM/3G] to distinguish them, but with the same Public Land Mobile Network (PLMN) ID to group them as part of the same mesh network. Different TAC [or LAC] is required to prepare the ‘UE Reject List’ according to TAC/LAC rejected.

It is pertinent to this patent application to understand the LTE UE's cell selection procedure because this process is leveraged to achieve instant mesh network topology changes by (1) changing the selection of a connection between a backhaul UE and its adjacent base stations in other mesh nodes; and (2) changing the selection of connections of UEs (i.e., which UE connects to which mesh node). Similar cell selection procedures of UMTS (3G) and 5G, are applicable for the same purposes. The UE (backhaul or radio access) measures the signals from every supported frequency band and compares them with a threshold for detection of the nearby cells. The UE then decodes Master Information Block (MIB) and System Information Blocks (SIBS) coming from the candidate cells and obtains identifiers such as Public Land Mobile Network (PLMN) id, Physical Cell ID (PCI), Tracking Area Code (TAC) of each cell/base station. The selection of the base station to attach to depends on the UE's pre-defined PLMN priorities and forbidden TAC lists, or signal strength. A ‘forbidden list’ is updated depending on the last errorless service taken or previously received rejections.

The rejection of a UE's attachment to a base station is leveraged for the change of connectivity topology method of this patent application. In LTE, a base station can reject the connection request of a UE. The rejection and its cause can be sent by the base station to UE in following exemplary messages;
ATTACH REJECT MESSAGE
TRACKING AREA UPDATE (TAU) REJECT MESSAGE
UPDATE REJECT MESSAGE
SERVICE REJECT MESSAGE
DETACH REQUEST MESSAGE

All these messages are well defined by the LTE standards. The Mobility Management Entity (MME) subcomponent of a Core Network has a configurable ‘Rejection List’. If a UE's IP address is in this list, the Core Network will deny the connection. If a UE is in the rejection list of the MME, the MME responds to that UE's ATTACH REQUEST MESSAGE with an ATTACH REJECT MESSAGE and responds to UE Tracking Area Update (TAU) with and TAU REJECT MESSAGE. Both rejection messages include a ‘rejection cause’ section. Once the UE receives a rejection of connection, it enters into a different state and stores the TAC ID (TAI) of the rejecting node in its ‘forbidden Tracking Area list’. Some exemplary rejection causes and their consequent states (as defined in 3GPP TS 24.301) are as follows;
#12 (Tracking area not allowed): The UE shall store the current TAI in the list of “forbidden tracking areas for regional provision of service” and enter the state EMM-DEREGISTERED.LIMITED-SERVICE.
#13 (Roaming not allowed in this tracking area): The UE shall store the current TAI in the list of “forbidden tracking areas for roaming”. Additionally, the UE shall enter the state EMM-DEREGISTERED.LIMITED-SERVICE or optionally EMM-DEREGISTERED.PLMN-SEARCH.
#15 (No suitable cells in tracking area): The UE shall store the current TAI in the list of “forbidden tracking areas for roaming” and enter the state EMM-DEREGISTERED.LIMITED-SERVICE.
#22 (Congestion): This rejection cause is sent with T3346 value, which is called the congestion timer. If the ATTACH REJECT message is received, the UE shall start timer T3346 with the value provided in the T3346 value. The UE stays in the current serving cell and applies the normal cell reselection process. The attach procedure is started if it is still needed when timer T3346 expires or is stopped.

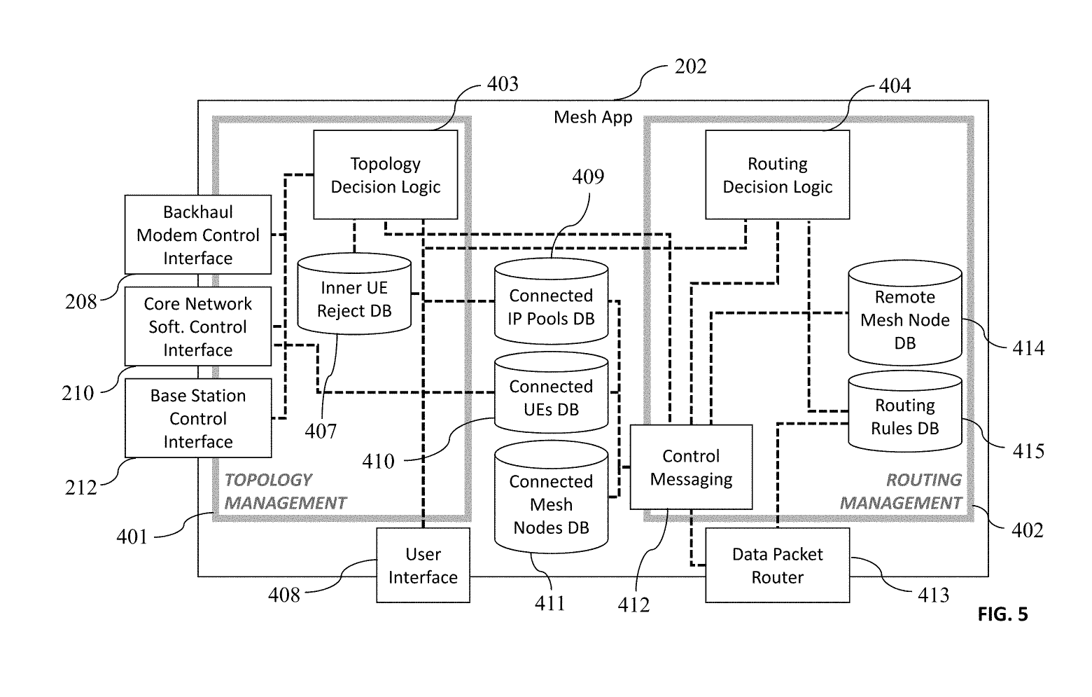

A block diagram of Mesh App, 202, of the mesh node, 206, is presented in FIG. 5. The Mesh App, 202, representing the system of invention, includes two functional decision mechanisms, topology management, 401, which encloses topology decision logic, 403, and routing management, 402, which encloses routing decision logic, 404. There are three general databases maintained by Mesh App; (1) database of backhaul connected neighbor mesh nodes, 411, which maintains IP addresses of neighbor mesh nodes and control/tunneled data sockets, (2) database of locally connected UEs, 410, which maintains IMSIs and IP addresses of the radio access UEs, and (3) database of connected IP pools, 409, which maintains IP and netmask of connected outer networks. Moreover, Mesh App contains a user interface, 408, that allows administrator to register IP pools of locally cable connected networks to database 409 and make additional configuration to decision logics 403 and 404. User interface 408 is where manual directives to change network topology can be entered into the system by the system administrator.

Topology decision logic, 403, has a direct connection for gathering information and directing the topology management of peripheral control connections. These connections are; (1) control interfaces of backhaul modems, 208, (2) control interface of core network software, 210, and (3) control interface of base station, 212. Moreover, topology management closure contains an inner UE reject database, 407, which maintains list of UE IMSIs, rejection causes, deciding mesh node identity, and validity time. When validity time for an entry time UE reject database times out, it is removed from the list. The inner UE reject database is the same list as that of the core network, except the rejection deciding mesh node identity. Note that sometimes a rejection of a backhaul UE is simply caused by a topology directive message received from an adjacent mesh node, with the goal of a directive of rejecting that UE's connection being to enable its connection to another mesh node. The main goal of the topology decision logic is to decide feasibility of every connected backhaul link or normal UE connection. Hence, it periodically evaluates the backhaul and normal UE links and discriminates or rejects infeasible links. A topology management action per this invention is triggered by the control interfaces of core network, 210, or base station, 212. Besides, backhaul modem control interface, 208, provides the received power information of active connection of each backhaul modem and provides the modem reset function. Backhaul modem reset function is triggered by topology decision logic, when the modem does not connect to any base station for a while, due to being rejected by all base stations, or when a long inner timer expires after an unsuccessful connection.

In the routing management procedure, control messaging function, 412, of FIG. 5 handles all requirements of the control information exchange with neighboring mesh nodes. Control messaging function, 412, is directly connected to data packet router, 413, and processes all incoming and outgoing data and control packets. When a new mesh node is connected with backhaul, control messaging block initiates an attempt to form a control connection. If the control connection is established, the data tunnel between mesh nodes are formed between data packet routers, 413. If the control connection fails, the UE is discriminated as a normal UE. Control messaging function, 412, is responsible for sending periodic or event-based control packets by reading inner databases. Moreover, control messaging function, 412, forwards the related information to topology decision logic, 403 and routing decision logic, 402, and stores received information about remote mesh nodes in the database, 414.

The purpose of the routing decision logic, 404, is to find the best routes for remote mesh nodes, UEs, and IP pools and storing the best routes in routing rules database, 415. Routing rules database, 415, includes entries for all known single IPs and IP pools, each of them is classified as local or remote with its remote tunnel direction. For every received packet, data packet router, 413, checks routing rules database, 415, and sends the packet to the stored next hop mesh node towards the destination. The routing decision logic, 404, updates routing rules database, 415, when a routing related control packet is received, a UE (or IP pool) attached or detached, or a neighbor mesh node is connected or disconnected with backhaul.

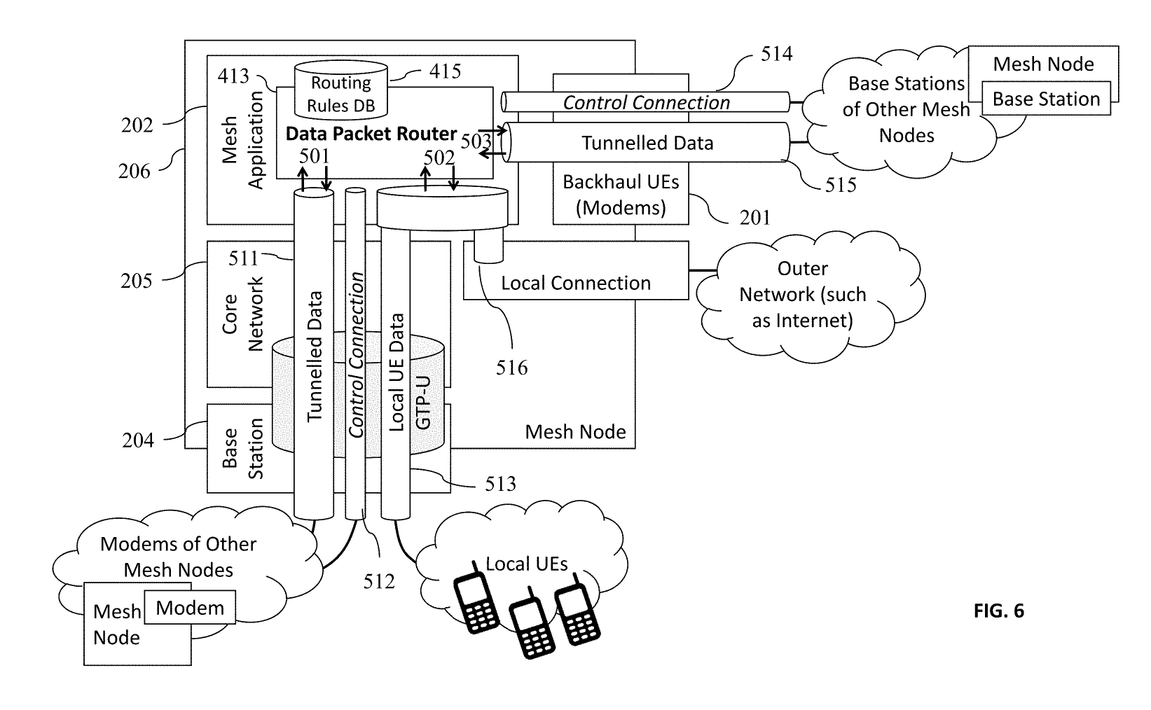

A block diagram that illustrates routing directions of data packet router, 413, is in FIG. 6. Mesh App establishes IP tunnels towards local and remote backhaul UEs. Doing so, the Mesh App can route IP packets between a source and a destination UE when these two UEs are attached to different mesh nodes, in a tunnel mode, i.e., retaining the source and destination UEs' IP addresses intact. The tunnel end points' IP addresses will be the mesh apps of the mesh nodes of the source and destination UEs; and (2) establishes control connections towards local and remote backhaul UEs so that it can share control messages with adjacent mesh nodes to primarily disseminate routing information and to alter the ‘UE reject lists’ to alter network connectivity as illustrated in FIG. 6. Mesh App's control connection 514 and tunneled data connection 515 are between the local backhaul modem, 503 and another mesh node's mesh app, whereas Mesh App's control connection 512 and tunneled data connection 511 are from another mesh node's backhaul modem (i.e., remote backhaul modem) towards the mesh node's Mesh App, 202. Also shown in FIG. 6 is the local data connection 502, which directly routes the packets towards mesh node's attached UEs, 513, or local cable (such as Ethernet) connection to outer networks, 516, (such as internet) with pre-defined IP pools.

The Control Messaging function, 412, of Mesh App, 202, per this invention is responsible for providing the inter-Mesh App control connectivity for data routing and control messaging to inform and modify network topology. The Mesh App either runs on the same computer with the Core Network or can be on a separate computer attached with a local area network to the Core Network's computer. The backhaul UE can be a simple interface card (such as a SIM card) on the computer that runs Core Network or the Mesh App.

Once turned on, each Mesh App detects the backhaul UE in the same node and makes sure that the detected backhaul UE connects to a remote Mesh Base Station, and not to the local Mesh Node. This is achieved by keeping these backhaul UEs IMSIs in the ‘UE reject list’ of that mesh node. Once the Mesh App detects that a connection has been established from its local backhaul modem to an adjacent mesh node, it will form an IP tunnel 515 in the uplink direction and a control connection 513 towards the Mesh App of the adjacent node as illustrated in FIG. 5. Mesh App is also responsible for detecting if any remote backhaul UEs that are connected to its own Base Station. If a backhaul UE's connection is detected, then IP tunnel 511 and control connection 512 towards the backhaul UE's Mesh App will be formed.

The control information exchange between any pair of Mesh Apps along the control connection is formulated in three simple messages:
HEARTBEAT message, which is sent periodically on each control connection and only includes the identity of the sending mesh node. It is not forwarded to other mesh nodes.
INFO message, which includes the sending mesh node's identity, sequence number, hop count, list of its ‘directly attached UEs’, list of its ‘cable connection IP pools’, list of ‘adjacent mesh nodes’, which are backhaul modem connected, with their signal powers. INFO message is sent to every control connection periodically, also in every instance of ‘attach’ and incoming ‘handover’ procedure. When mesh node A receives an INFO message from its neighbor B, it increments the hop count, and then forwards it to its other neighbor C. Neighbor C records the information in the message, increments the hop count and forwards it to another neighbor D, etc. Doing so, mesh node C, for example, knows that a particular UE attached to neighbor B is two hops away.
TOPOLOGY DIRECTIVE message, which includes topology alteration directive that is sent from one Mesh App to another neighboring Mesh App, including sender mesh node's identity, and the directive's validity time. The directive may be (1) rejection request for particular backhaul modems, or (2) load balancing request for radio access UEs. The directives may come manually from the system administrator using the mesh app's user interface, or alternatively by deploying a policy server and a policy database within the topology management application, wherein the policies, if any, regarding backhaul connections and radio access UEs are stored in the policy database.

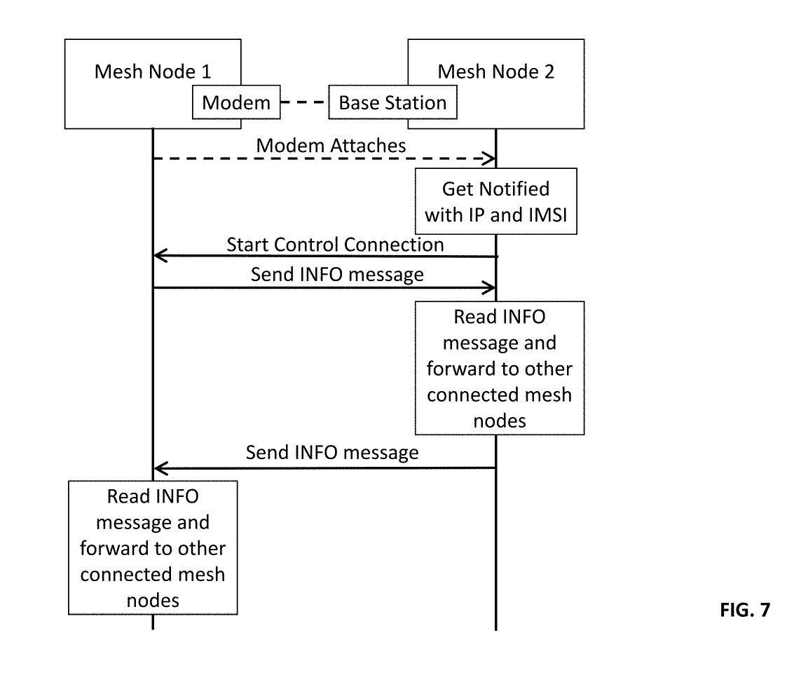

The Mesh App maintains two types of timers for the control information: (1) a connection timer for the control and data connections to test if a connection is still alive for every adjacent mesh node connection; (2) a mesh node timer for every known mesh node in the network to test if its routing information is fresh, meaning it is still valid. An exemplary simplified control connection setup procedure between a backhaul modem and a base station according to an aspect of this invention between two adjacent mesh nodes is performed as illustrated in FIG. 7. First, backhaul modem of Mesh node 1 connects to a base station of the adjacent Mesh Node 2. Then, the base station end of the link gets notified by the connection and identifies that the connecting UE as a backhaul modem from its IMSI. Mesh Node 2 provides an IP address to the backhaul modem of Mesh Node 1 from its own IP address pool, and starts a transport layer connection, such as TCP or SCTP. Note that the two end-points of this control connection are the Mesh Apps of the two Mesh Nodes 1 and 2. If Mesh Node 1 accepts the connection, it immediately sends its node's INFO message to Mesh Node 2. In turn, Mesh Node 2 processes the message, and forwards it to its neighbors. Mesh node 2 responds to Mesh Node 1 with its own INFO message. In turn, Mesh Node 1 processes the message and forwards it to its neighbors. Note that the Mesh App is where the INFO messages are received and processed.

Mesh App should always configure the core network to reject its own backhaul modem connection attempts to avoid connecting to itself. Depending on all information obtained from other mesh nodes through the INFO messages and additional internal configuration information, a Mesh App can decide on rejecting the connection of certain backhaul modems of neighboring mesh nodes to steer the connectivity topology of the network. Note that the network connectivity/topology is governed by the backhaul modem-to-base station connections of adjacent nodes as illustrated in FIGS. 4A and 4B. It may simply decide to reject normal UEs as well to transfer load to other mesh nodes. The topology management is achieved by: (1) adding certain backhaul modem IMSIs to the ‘UE rejection list’ and forcing them to detach for backhaul topology management, (2) Adding normal UE IMSIs to the rejection list and forcing them to detach for forced load management of UEs (i.e., transferring them from one mesh node to another without a handover), and (3) adding normal UE IMSIs to the rejection list, and then commanding the mesh node to perform handover for load balancing without interruption of active data connections. For each rejection list entry, the rejection cause such as #15 may cause the UE not to reconnect to that mesh node until the UE is reset, or #22 may cause the UE not to reconnect to the mesh node only during a pre-defined timer.

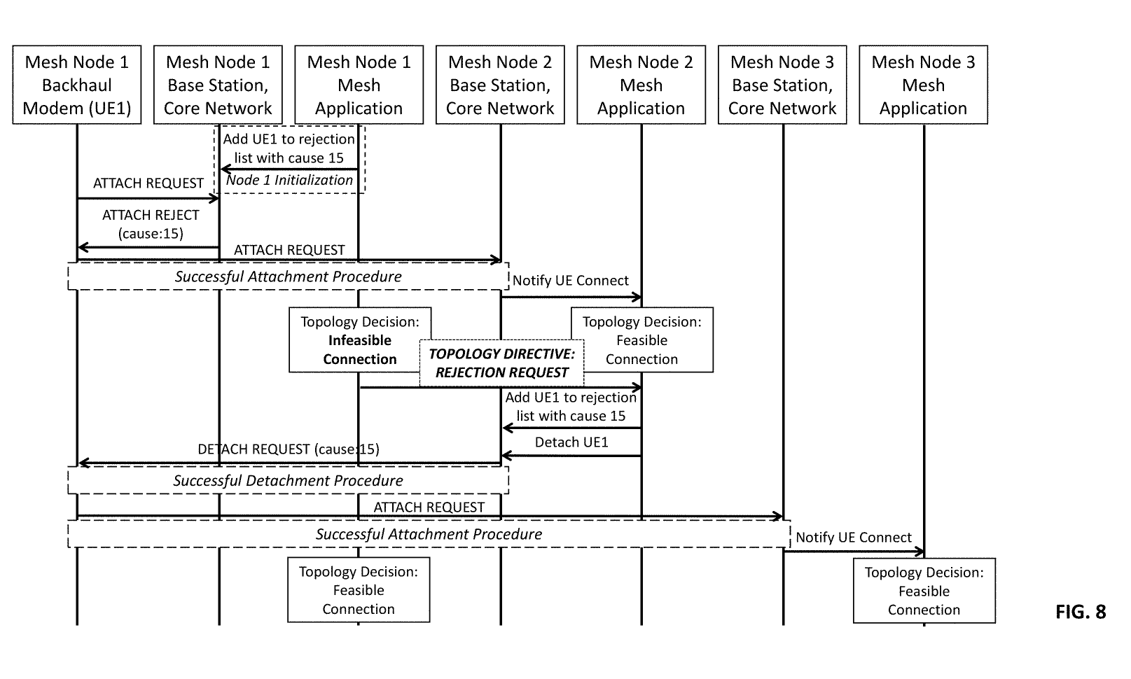

An exemplary scenario of topology management is illustrated in FIG. 8, wherein a sequence of topology management events when a backhaul modem on mesh node 1 tries to connect amongst 3 mesh nodes is shown. As mentioned previously, every mesh node has to configure its own core network/base station to reject its own backhaul modems' ‘attach request’ with a rejection cause 15: “No suitable cells in tracking area” in this specific scenario. The sequence of events for topology management is as follows: (1) when backhaul modem boots up, it first attempts to connect to its own base station because it has the highest Reference Signal Received Power (RSRP). But, this ‘attach request’ is rejected with ‘cause 15’. Hence, the backhaul modem adds its own mesh node's TAC Id to its ‘forbidden TAI list’ and does not attempt to connect to a base station with the same TAC Id until a reboot; (2) Next, backhaul modem successfully attaches to adjacent mesh node 2. After backhaul UE attaches, both of the topology decision logics of the mesh node 1 and 2 decides on if this backhaul connection is a feasible one. In this scenario, topology decision logic of the mesh node 1 decides based on previously measured signal powers or possibly using other types of preconfigured information that this connection is topologically undesirable and therefore declared infeasible. Mesh App of the mesh node 1 requests, by sending a TOPOLOGY DIRECTIVE message to mesh node 2, for not accepting the connection of its backhaul modem by core network of mesh node 2. Next, Mesh App of node 2 first configures the rejection list of its core network with this backhaul UE's IMSI. Then, it triggers the detachment of the UE. In this case, the rejection cause can be transmitted to the UE by either a detach request or in attach reject when it re-attempts to connect mesh node 2; (3) When backhaul UE gets the rejection from mesh node 2, it attempts to attach mesh node 3, which succeeds. As a result of this sequence of operations, mesh node 1 connects to mesh node 3 via backhaul model of mesh node 1.

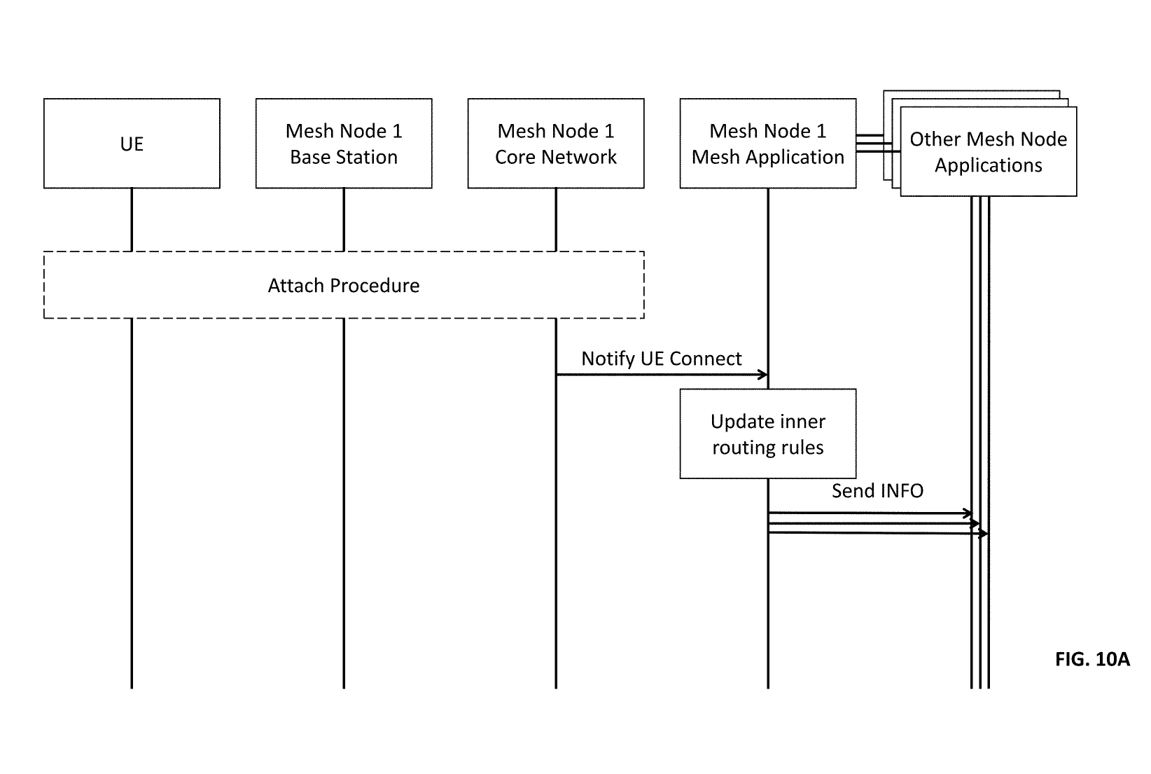

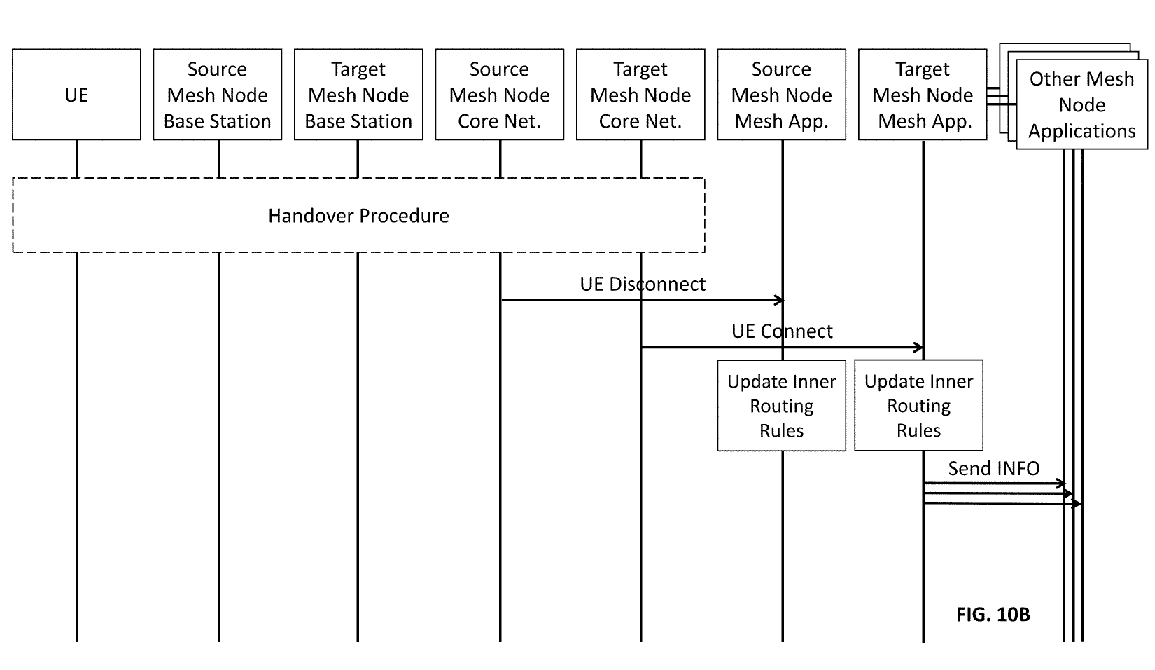

The Core Network knows the IP addresses of all UEs and Backhaul UEs attached to itself through the registry process, and thus it knows how to route data packets to destinations within the coverage of its collocated mesh base station. However, it can't route IP traffic destined to radio access UEs attached to different mesh nodes. The Core Network continuously notifies the Mesh App of the ‘Network Attach’, ‘Network Detach’, and ‘Handover’ events to keep an accurate registry of all locally supported IP end points. Doing so, the Mesh App obtains all local IP addresses from the attached Core Network. Meanwhile, it learns the remote IP addresses from the Mesh Apps in other mesh nodes to be able to route packets beyond the coverage of its own Mesh Node. The neighbor Mesh Apps, therefore, exchange periodic or event-based INFO messages on the control connection to obtain routing updates in the network. Besides periodic INFO message broadcasts, the INFO message is instantly generated in two events; (1) when a UE attaches as illustrated in FIG. 10A, and (2) when a UE handover occurs towards the mesh node as illustrated in FIG. 10B. The Mesh App may elect to group some of the attach/handover events in a single INFO message to minimize the packets broadcasted—while carefully considering to minimize potential packet losses due to instant configuration changes while waiting to group events. When a Mesh App receives an update of a control message from a peer Mesh App, it reads the content and updates its routing tables accordingly. Thus, if there is more than one feasible route to reach a destination, the receiving Mesh App's routing logic is supposed to optimize and decide the shortest routing path. The Mesh App is further responsible to include the IP addresses of the neighbor Core Networks and Base Stations in its routing tables. The Core Network IP addresses will be necessary for handing radio access UEs between Mesh Nodes.

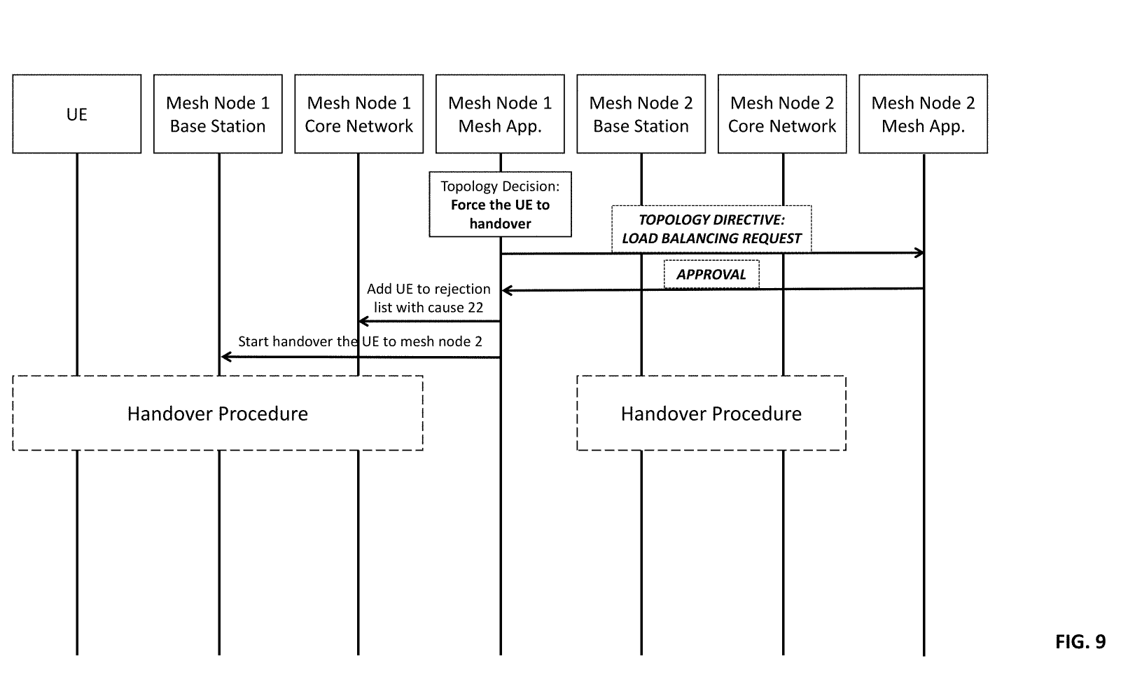

FIG. 9 illustrates a simple load balancing message sequence, where a UE connected to one mesh node is forced to handover to another mesh node. The UE is initially connected to mesh node 1. Due to large number of connected UEs to mesh node 1 and the aggregate throughput of its base station, the topology decision logic of mesh node 1 decides to move a UE from mesh node 1 to mesh node 2 for load balancing, resulting in a forced handover. For this purpose, it first sends a topology directive message to mesh node 2, which includes that UE's IMSI and IP address in request to enable a handover for load balancing. Mesh App of mesh node 2 responds after evaluating the feasibility of the requested move. After receiving approval, Mesh App of mesh node 1 first configures its core network with the added the UE into its ‘reject list’ with a UE rejection clause of #22 indicating congestion, and triggers handover through its interface to the base station. After the triggered handover, a standard handover procedure is implemented from mesh node 1 to mesh node 2. The congestion cause #22 is set with a timer, so that when that UE attempts to handover or reselect mesh node 1, UE will be rejected if the pre-configured timer has not been timed out yet.

FIG. 10A illustrates the attachment procedure of a new UE to a mesh node. Upon attachment, the Mesh App adds the UE's IP address to its routing tables and also triggers an INFO message to update its neighbors about the change in routing. FIG. 10B illustrates the handover procedure of a UE from a source node to a target node. The source Mesh App deletes the UE from its routing tables while the target Mesh App adds the UE to its routing tables, and both of these changes trigger INFO messages from the source and target Mesh Apps towards their adjacent mesh nodes' Mesh Apps. Since INFO message exchange has to be through the backhaul control connection over the air interface, each mesh node needs to know not only the remote IP addresses of the radio access UEs, but also the neighbor Core Networks and Mesh Base Stations.

Each Mesh App is responsible for storing and updating of its routing table based on its own information of attachment/detachment/handover of local UEs and the received INFO message contents from neighbors. The Mesh App receives the packets by its virtual network interface, which is formed by data packet router, arriving from an attached radio access UE, and based on the destination IP address of the incoming packets, it will either send the packets directly to the Core Network for a local transmission or tunnel it to send to a remote Mesh App. When a UE attaches or detaches from the Core Network or if there is a handover, a notification message is sent from the Core Network to the local Mesh App so that the Mesh App updates its local routing table accordingly.

The Mesh App can't route packets directly to the destination of the IP packet when the destination address is not within the coverage of the Mesh Node of that Mesh App because, the destination IP address of the packet is not known within the Mesh Node and it would not be sufficient to simply bypass the radio access network and the air interface. Therefore, it has to be tunneled across the two mesh nodes, wherein the source and destination radio access UEs are within the coverage areas of these two Mesh Nodes.

Not all Mesh Nodes are created equal. One Mesh Node may need more resources than others and/or may require prioritization. For example, a sink node may require prioritization because it provides Internet connection and therefore most of the traffic gets concentrated around it. In other cases, number of radio access UEs connected to a specific Mesh Node would be much higher than others, or its coverage area would be large. In these cases, the topology management subcomponent of the Mesh App adjusts the number of UEs connected to a mesh node accordingly using TOPOLOGY DIRECTIVE messages.

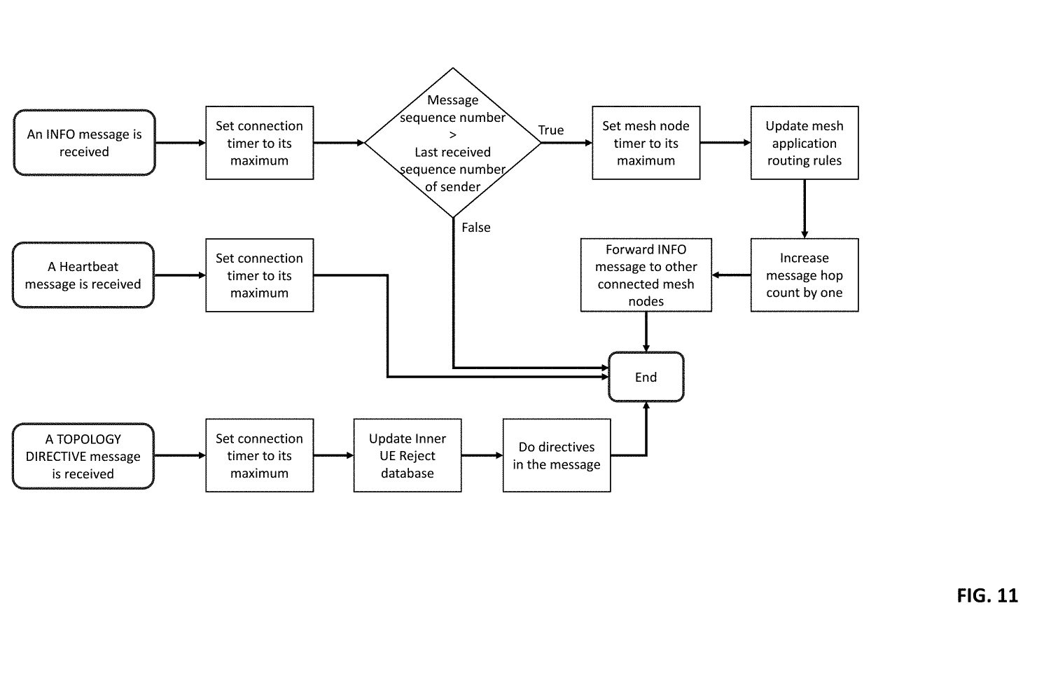

A simple flowchart showing the control operations of the Mesh App is given in FIG. 11. The Mesh App receives three types of control messages: HEARTBEAT, INFO, and TOPOLOGY DIRECTIVE and two types of timers. For every neighbor mesh node connection, the Mesh App maintains a ‘connection timer’ to test if the connection is still online. For every known mesh node in the network, Mesh App maintains a ‘mesh node timer’ to test if its routing information is still valid. When the Mesh App receives a HEARTBEAT, it resets the connection timer to maximum. When the Mesh App receives an INFO, it sets the connection timer as well as the mesh node timer of that node to maximum. If it is a new INFO message, it first checks its sequence number to prevent looping, and if it is a new INFO message then it updates its own routing tables accordingly and forwards the INFO message to its adjacent mesh nodes. While forwarding the INFO message, it increases the hop count by one so to indicate it is coming from another mesh node and not originating by itself. The TOPOLOGY DIRECTIVE message is not broadcasted by the receiving node to any other nodes. The topology decision logic gets it and stores the directive in its database with its validity time. Then, the topology decision logic acts according to the directive in the message. The UE rejection rule in the message is assumed to be valid only for the validity time.

Many of the above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

### CONCLUSION

A system and method is developed to dynamically change the topology of a mesh network connectivity comprised of many mesh nodes and route IP packets across the network in a wireless network, wherein an IP tunnel and a control connection are established between a pair of mesh nodes terminating on the system of invention, so called Mesh App. The Mesh App has several key functions such as collecting local wireless user equipment IP addresses from the local Core Network, and remote IP addresses and routing information from its neighbor Mesh Apps, enabling routing of data traffic hop by hop across the network. Furthermore, it changes the UEs in the ‘reject list’ forcing the disconnection of certain UEs and backhaul modems so as to altering the topology or the network, and distributing the topology change information to its neighbors.

1. A method as implemented in a mesh network, the mesh network comprising at least a first mesh node and a remote second mesh node, the first mesh node comprising a first base station, a first backhaul user equipment (UE), and a first integrated computer implementing a first core network and running a first mesh application, the first mesh node directly attached to at least a first radio access user terminal, the second mesh node comprising a second base station, a second backhaul user equipment (UE), and a second integrated computer implementing a second core network and running a second mesh application, the second mesh node directly attached to at least a second radio access user terminal, the first mesh node interconnected with the second mesh node via the first backhaul UE communicating with the second base station over an air interface to provide the backhauling or hopping of data traffic, the method as implemented in the first mesh node comprising:
establishing a control connection towards the second mesh application of the second mesh node via the first backhaul UE's communicating with the second base station of the second mesh node, the control connection exchanging control messages; and
establishing a data connection towards the second mesh application of the second mesh node to exchange data packets between the first radio access user terminal attached to the first mesh node and the second radio access user terminal attached to the second mesh node.

2. The method of claim 1, wherein the control messages exchanged on the control connection are used for topology management and data packet routing, the control messages comprising any of, or a combination of, the following:
a) a heartbeat message informing other end of the control connection that the control connection is alive;
b) an info message to inform other end of the control connection that (i) the data connection is alive, and (ii) about at least an identity of a sending mesh node, a list of directly attached radio access user equipment identifiers of the sending mesh node, and a list of adjacent mesh nodes of the sending mesh node; and
c) a topology directive message to inform other end of the control connection about a requested topology management action on an attachment of a remote backhaul UE or a particular local radio access user equipment to its base station.

3. The method of claim 2, wherein the requested topology management action on the attachment is a rejection of an attachment request of a remote backhaul UE or a particular local radio access user equipment to its base station.

4. The method of claim 2, wherein the info message is sent on an event driven basis when a local radio access terminal or a backhaul user equipment attach, detach, handover, or reselect the cell.

5. The method of claim 2, wherein the info message is sent on an event driven basis when another mesh node's local radio access or backhaul user equipment attaches to said node.

6. The method of claim 1, wherein the data connection is an IP tunnel between mesh applications of adjacent nodes.

7. A topology alteration method as implemented in a mesh network, the mesh network comprising at least a first mesh node, a remote second mesh node, and a remote third mesh node, the first mesh node comprising a first base station, a first backhaul user equipment (UE), and a first integrated computer implementing a first core network and running a first mesh application, the first mesh node directly attached to at least a first radio access user terminal, the second mesh node comprising a second base station, a second backhaul user equipment(UE), and a second integrated computer implementing a second core network and running a second mesh application, the second mesh node directly attached to at least a second radio access user terminal, the third mesh node comprising a third base station, a third backhaul user equipment (UE), and a third integrated computer implementing a third core network and running a third mesh application, the third mesh node directly attached to at least a third radio access user terminal, the first mesh node interconnected with the second mesh node via the first backhaul UE communicating with the second base station over a first air interface to provide the backhauling or hopping of data traffic, and the second mesh node interconnected with the third mesh node via the second backhaul UE communicating with the third base station over a second air interface to provide the backhauling or hopping of data traffic, the method comprising:
a) each mesh application at a corresponding mesh node storing a User Equipment (UE) reject list containing a listing of those UE whose connection attempt to that corresponding mesh node will be rejected with an associated reject reason, the UE reject list containing at least the identifier of the corresponding mesh node's backhaul UE, so that when the corresponding mesh node's backhaul terminal tries to attach to its local base station, the connection is rejected by the local base station to force corresponding mesh node's backhaul user terminal to attach to a remote mesh node's base station;
b) the first mesh application sending a topology directive message to the second mesh application to request the rejection of a connection request of the first backhaul UE to the second mesh application, the second mesh application adding the first backhaul UE's identifier to its UE reject list and rejecting the first backhaul UE's attachment to the second base station; and
c) the first backhaul UE being disconnected from the second base station, attempting to attach the third base station, connecting to the third base station and therefore altering the topology of connectivity between the three mesh nodes.

8. The method of claim 7, wherein the method further comprising the steps of:
a) the first mesh application associated with the first mesh node, whose base station is connected to the first radio access user terminal sends said topology directive message to the second mesh application associated with the second mesh node to request handover the first radio access user terminal to the second mesh node;
b) upon approval of the handover by the second mesh application associated with the second mesh node, the first mesh application associated with the first mesh node adding the first radio access user terminal into its UE reject list and triggering a handover from the first base station associated with the first mesh node to the second base station associated with the second mesh node; and
c) the first radio access user terminal disconnecting from the first base station associated with the first mesh node and connecting to the second base station associated with the second mesh node.

9. The method of claim 7, wherein identifiers of the radio access terminals or backhaul UEs are at least an International Mobile Subscriber Identity (MST) address and an IP address.

10. The method of claim 7, wherein the UE reject list further comprises a listing of UEs to be rejected, identifier of a mesh application deciding a directive, IMSI of each rejected UE, and a rejection cause and a validity timer of each directive.

11. A mesh network comprising:
a first mesh node comprising a first base station, a first backhaul user equipment (UE), and a first integrated computer implementing a first core network and running a first mesh application, the first mesh node directly attached to at least a first radio access user terminal,
a second mesh node comprising a second base station, a second backhaul user equipment (UE), and a second integrated computer implementing a second core network and running a second mesh application, the second mesh node directly attached to at least a second radio access user terminal,
the first mesh node interconnected with the second mesh node via the first backhaul UE communicating with the second base station over an air interface to provide the backhauling or hopping of data traffic,
the first mesh node establishes a control connection towards the second mesh application of the second mesh node via the first backhaul UE's communicating with the second base station of the second mesh node, the control connection exchanging control messages; and establishes a data connection towards the second mesh application of the second mesh node to exchange data packets between the first radio access user terminal attached to the first mesh node and the second radio access user terminal attached to the second mesh node.

12. The mesh network of claim 11, wherein the control messages exchanged on the control connection are used for topology management and data packet routing, the control messages comprising any of, or a combination of, the following:
a) a heartbeat message informing other end of the control connection that the control connection is alive;
b) an info message to inform other end of the control connection that (i) the data connection is alive, and (ii) about at least an identity of a sending mesh node, a list of directly attached radio access user equipment identifiers of the sending mesh node, and a list of adjacent mesh nodes of the sending mesh node; and
c) a topology directive message to inform other end of the control connection about a requested topology management action on an attachment of a remote backhaul UE or a particular local radio access user equipment.

13. The mesh network of claim 12, wherein the requested topology management action on the attachment is a rejection of an attachment request of a remote backhaul UE or a particular local radio access user equipment to its base station.

14. The mesh network of claim 12, wherein the info message is sent on an event driven basis when a local radio access terminal or backhaul user equipment attach, detach, handover, or reselect the cell.

15. The mesh network of claim 12, wherein the info message is sent on an event driven basis when another mesh node's local radio access or backhaul user equipment attaches to said node.

16. The mesh network of claim 11, wherein the data connection is an IP tunnel between mesh applications of adjacent nodes.

17. A mesh network allowing topology alteration comprising:
a first mesh node comprising a first base station, a first backhaul user equipment (UE), and a first integrated computer implementing a first core network and running a first mesh application, the first mesh node directly attached to at least a first radio access user terminal,
a second mesh node comprising a second base station, a second backhaul user equipment(UE), and a second integrated computer implementing a second core network and running a second mesh application, the second mesh node directly attached to at least a second radio access user terminal,
a third mesh node comprising a third base station, a third backhaul user equipment (UE), and a third integrated computer implementing a third core network and running a third mesh application, the third mesh node directly attached to at least a third radio access user terminal,
the first mesh node interconnected with the second mesh node via the first backhaul UE communicating with the second base station over a first air interface to provide the backhauling or hopping of data traffic, and the second mesh node interconnected with the third mesh node via the second backhaul UE communicating with the third base station over a second air interface to provide the backhauling or hopping of data traffic, wherein:
a) each mesh application at a corresponding mesh node storing a User Equipment (UE) reject list containing a listing of those UE whose connection attempt to that corresponding mesh node will be rejected with an associated reject reason, the UE reject list containing at least the identifier of the corresponding mesh node's backhaul UE, so that when the corresponding mesh node's backhaul terminal tries to attach to its local base station, the connection is rejected by the local base station to force corresponding mesh node's backhaul user terminal to attach to a remote mesh node's base station;
b) the first mesh application sending a topology directive message to the second mesh application to request the rejection of a connection request of the first backhaul UE to the second mesh application, the second mesh application adding the first backhaul s identifier to its UE reject list and rejecting the first backhaul UE's attachment to the second base station; and
c) the first backhaul UE being disconnected from both the first and second base stations attempting to attach the third base station, connecting and therefore altering the topology of connectivity between the three mesh nodes.

18. The mesh network of claim 17, wherein:
d) the first mesh application associated with the first mesh node, whose base station is connected to the first radio access user terminal sends said topology directive message to the second mesh application associated with the second mesh node to request handover the first radio access user terminal to the second mesh node;
e) upon approval of the handover by the second mesh application associated with the second mesh node, the first mesh application associated with the first mesh node adding the first radio access user terminal into its UE reject list and triggering a handover from the first base station associated with the first mesh node to the second base station associated with the second mesh node; and
f) the first radio access user terminal disconnecting from the first base station associated with the first mesh node and connecting to the second base station associated with the second mesh node.

19. The mesh network of claim 17, wherein identifiers of the radio access terminals or backhaul UEs are at least an International Mobile Subscriber identity (IMSI) address and an IP address.

20. The mesh network of claim 17, wherein the UE reject list further comprises a listing of UEs to be rejected, identifier of a mesh application deciding a directive, IMSI of each rejected UE, and a rejection cause and a validity timer of each directive.
